(19) United States
(12) Patent Application Publication
(10) Pub. No.: US 2026/0327018 A1
(43) Pub. Date: Oct. 22, 2026

(54) ARTICLE-TURNING DEVICE

(71) Applicant: The Procter & Gamble Company, Cincinnati, OH (US)

(72) Inventors: Kazuaki TAMEISHI, Kobe (JP); Clifford Theodore PAPSDORF, LOVELAND, OH (US)

(21) Appl. No.: 19/463,188

(22) Filed: Jan. 29, 2026

Related U.S. Application Data
(60) Provisional application No. 63/756,483, filed on Feb. 10, 2025.

(51) Int. Cl. B65G 47/244

(52) U.S. Cl. CPC B65G 47/244

(57) ABSTRACT

Provided is a device for changing an orientation of an article while moving the article in an orbital path about a first axis from an in-feed position to an output position. The device comprises a central shaft co-axial with the first axis, an article turning unit and a body. The body is configured to rotate about the first axis, thus rotating the article turning unit about the first axis. Gear sections are provided intermittently around the circumference of the central shaft. The article turning unit comprises an article holder configured to transport an article from the in-feed position to the output position, and an article turning gear configured to engage with the gear sections to cause the article holder to rotate about a second axis.

### CROSS REFERENCE TO RELATED APPLICATION

This application claims the benefit, under 35 U.S.C. § 119(e), of U.S. Provisional Application No. 63/756,483, filed Feb. 10, 2025, the entire disclosure of which is incorporated herein by reference.

### FIELD

The disclosure relates to the field of series production, in particular, to devices for changing an orientation of an article, such as turning devices and turn-and-repitch devices.

### BACKGROUND

It is sometimes desirable to change an orientation of an article during manufacture and/or packaging of the article. A turning device or a turn-and-repitch device may be used to perform a change in orientation of an article.

A turning device or turn-and-repitch device may comprise a barrel cam and one or more article holding elements configured to move in an orbital path about the barrel cam to convey an article from an in-feed position to an output position. A cam follower engaged with the barrel cam is coupled to each article holding element, and the cam profile is configured such that the engagement of each cam follower with the barrel cam causes each article holding element to rotate as each article holding element moves about the barrel cam. In this way, an article conveyed by one of the article holding elements is rotated between the in-feed position and the output position. The cam profile may be configured such that each article holding element does not rotate at the in-feed position and the output position.

The cam profile is designed for a particular process performed on a particular type of article. If the design of the article and/or the production process is changed, a different cam profile may be required. A new cam with the required cam profile must then be designed and manufactured.

A replacement cam is also required periodically over the lifetime of a typical turning device or turn-and-repitch device, as the cam deteriorates over time.

As the cam is one of the largest parts of a typical turning device or turn-and-repitch device, manufacturing a new cam (either because a different cam profile is required or due to regular maintenance of the device) is time-consuming and costly. Further, replacement of the cam requires disassembly of the entire device.

### SUMMARY

According to an aspect of the present disclosure, there is provided a device for changing an orientation of an article while moving the article in an orbital path about a first axis from an in-feed position to an output position, the device comprising: a central shaft co-axial with the first axis, the central shaft comprising circumferentially alternating first sectors and second sectors, wherein a gear section is provided on each first sector; an article turning unit comprising: an article holder for receiving the article at the in-feed position, holding the article while moving the article between the in-feed position and the output position, and releasing the article at the output position, the article holder being rotatable about a second axis to rotate the article between an input orientation, at the in-feed position, and an output orientation, at the output position; and an article turning gear configured to engage with the gear sections on the central shaft, wherein the article turning gear is coupled to the article holder for rotating the article holder about the second axis; and a body that is rotatable about the first axis, wherein the article turning unit is mounted to the body so that the article turning unit is rotatable about the first axis.

This provides a device for changing an orientation of an article that can be manufactured and modified more easily and at a lower cost than existing devices. If the design of the article and/or the production process is changed, the positions of the gear sections along the circumference of the central shaft may be changed more easily than replacing the cam used in existing devices.

In some embodiments, each gear section is a bevel gear section; and the article turning gear is a bevel gear.

In some embodiments, the first axis and second axis are non-parallel to one another.

In some embodiments, the second axis is perpendicular to the first axis.

In some embodiments, a track section is provided on each second sector; and the article turning unit further comprises a track engagement element configured to engage with the track sections on the central shaft.

Each track section guides the motion of the article turning unit between adjacent gear sections. The track engagement element and track sections may be configured such that engagement of the track engagement element with each track section restricts rotation of the article turning gear.

In some embodiments, the track engagement element is offset from an axis of rotation of the article turning gear.

In this way, rotation of the article turning gear is restricted while the track engagement element is engaged with each track section.

In some embodiments, each gear section overlaps in a circumferential direction with an adjacent track section.

Where the track engagement element is offset from the axis of rotation of the article turning gear, this ensures that the article turning gear remains engaged with the gear section until the track engagement element is engaged with the track section.

In some embodiments, at least a first portion of each track section defines a circumferential arc perpendicular to the first axis, such that engagement of the track engagement element with the first portion causes the track engagement element to move in an arc perpendicular to the first axis.

Movement of the track engagement element in an arc perpendicular to the first axis does not cause rotation of the article turning gear.

In some embodiments, each track section further comprises a transition region at one or both ends of the track section, each transition region being curved so as to deviate in an axial direction from a circumferential arc perpendicular to the first axis.

Engagement of the track engagement element with a transition region causes rotation of the article turning gear, providing controlled acceleration and/or deceleration of the article turning gear between gear sections and track sections. This reduces an impact on the article turning gear. A transition region to control acceleration of the article turning gear reduces a likelihood of damage to the article turning gear when meshing with the start of a gear section. A transition region to control deceleration improves overall mechanical durability.

In some embodiments, each track section comprises a pair of rails.

In some embodiments, each track engagement element comprises a slider configured to slide within the pair of rails.

In some embodiments, each track engagement element comprises a roller configured to move within the pair of rails.

In some embodiments, each track section comprises a rail.

In some embodiments, each track engagement element comprises a pair of sliders, each slider being configured to engage with a respective side of the rail to thereby slide along the rail.

In some embodiments, each track engagement element comprises a pair of rollers, each roller being configured to engage with a respective side of the rail to thereby move along the rail.

In some embodiments, the article turning unit further comprises a reducer provided between the article turning gear and the article holder, wherein the reducer is configured to modify an amount of rotation of the article holder relative to an amount of rotation of the article turning gear such that the article holder is configured to rotate at a slower rate than the article turning gear.

In this way, the article turning gear and the article holder may each rotate by a respective desired amount.

In some embodiments, the reducer has a reduction ratio of 1:4.

This results in the article holder rotating by 90° for each 360° rotation of the article turning gear.

In some embodiments, the gear sections are configured such that engagement of the article turning gear with each gear section causes the article turning gear to rotate in the same direction.

In some embodiments, the gear sections comprise: a first gear section, configured such that engagement of the article turning gear with the first gear section causes the article turning gear to rotate in a clockwise direction; and a second gear section, configured such that engagement of the article turning gear with the second gear section causes the article turning gear to rotate in a counterclockwise direction.

This enables the article holder to have the same input orientation each time the article holder reaches the in-feed position and the same output orientation each time the article holder reaches the output position. This enables a more effective design of the article holder.

In some embodiments, the gear sections and the article turning unit are together configured such that engagement of the article turning gear with each gear section causes the article holder to rotate by 90° between a first end of the gear section and a second, opposite end of the gear section.

In some embodiments, the first sectors and second sectors are configured such that a 360° rotation of the body about the first axis comprises: a first rotation of the body about the first axis, during which the article holder does not rotate about the second axis; a second rotation of the body about the first axis, during which the article holder rotates about the second axis; a third rotation of the body about the first axis, during which the article holder does not rotate about the second axis; and a fourth rotation of the body about the first axis, during which the article holder rotates about the second axis, wherein the body rotates by a greater amount during the first rotation than the third rotation.

A greater amount of rotation of the body during the first rotation than the third rotation may be used for rectangular-shaped articles, as the length of the orbital path for which no rotation of the article holder is required will depend on the orientation of the article. The device may be configured such that the article turning unit is at the in-feed position during the first rotation or such that the article turning unit is at the output position during the first rotation, depending on the input and output orientations of the article.

In some embodiments, the first sectors and second sectors are configured such that the body rotates by: 90° during the first rotation; 115° during the second rotation; 40° during the third rotation; and 115° during the fourth rotation.

This provides the same motion as many existing devices for changing an orientation of an article.

In some embodiments, the first sectors and second sectors are configured such that the body rotates by: 90° during the first rotation; 120° during the second rotation; 30° during the third rotation; and 120° during the fourth rotation.

This enables a simpler gear ration between the article turning gear and each gear section.

### BRIEF DESCRIPTION OF THE DRAWINGS

FIG. 1 illustrates a schematic cross-sectional view of a device for changing an orientation of an article, according to an example;

FIG. 2 illustrates a schematic perspective view of the device of FIG. 1;

FIG. 3 illustrates a part of the orbital path of the article turning gear and article holder of the device of FIG. 1 about the first axis A₁;

FIG. 4 illustrates a part of the orbital path of an article turning gear and article holder of another device for changing an orientation of an article;

FIG. 5 illustrates a part of the orbital path of an article turning gear and article holder of yet another device for changing an orientation of an article; and

FIG. 6 illustrates an apparatus comprising a device for changing an orientation of an article, according to an example.

### DETAILED DESCRIPTION

Provided is a device for changing an orientation of an article while moving the article in an orbital path about a first axis from an in-feed position to an output position. The device comprises a central shaft co-axial with the first axis, an article turning unit and a body. The body is configured to rotate about the first axis, thus rotating the article turning unit about the first axis. Gear sections are provided intermittently around the circumference of the central shaft. The article turning unit comprises an article holder configured to transport an article from the in-feed position to the output position, and an article turning gear configured to engage with the gear sections to cause the article holder to rotate about a second axis.

The device may be used to change the orientation of any suitable article or component, including absorbent articles such as diapers, sanitary pads, incontinence pads, pantiliners, and the like, in a finished state or partially-finished state. The device may, for example, be employed in a system for manufacturing and/or packaging an article.

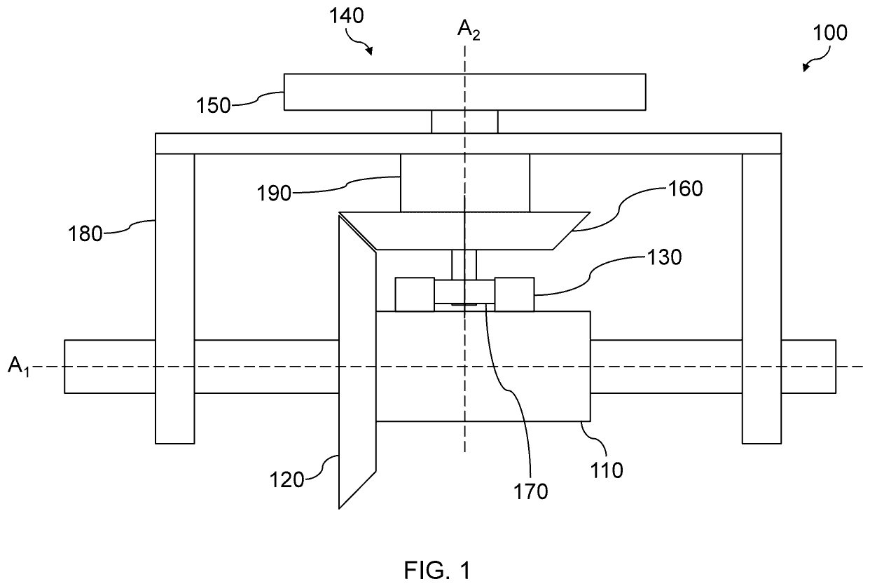

FIG. 1 illustrates a schematic cross-sectional view of a device 100 for changing an orientation of an article, according to an example. The device 100 is configured to change an orientation of an article while moving the article in an orbital path about a first axis A₁ from an in-feed position to an output position, as described in more detail below.

The device 100 comprises a central shaft 110, which is co-axial with the first axis A₁, and comprises circumferentially alternating first sectors and second sectors. A gear section 120 is provided on each first sector. In FIG. 1, a track section 130 is provided on each second sector. Although only one gear section and one track section are visible in FIG. 1, it is to be understood that the device 100 illustrated in FIG. 1 further comprises another gear section and another track section that are not visible in the cross-sectional view of FIG. 1 (i.e. the central shaft comprises two first sectors and two second sectors).

The device 100 further comprises an article turning unit 140, which comprises an article holder 150 and an article turning gear 160 configured to engage with the gear sections 120. In FIG. 1, the article turning unit 140 further comprises a track engagement element 170 configured to engage with the track sections 130.

The device 100 further comprises a body 180, to which the article turning unit 140 is mounted. The body 180, and thus the article turning unit 140, is rotatable about the first axis A₁. In FIG. 1, the body 180 takes the form of a housing, which is rotatably mounted to the central shaft 110, thus enabling the body and the article turning unit to rotate about the first axis A₁. In this way, the article holder 150 of the article turning unit 140 is moveable along an orbital path between the in-feed position and the output position. The device 100 may further comprise a motor (not shown in FIG. 1) to drive rotation of the body about the first axis A₁.

The article holder 150 of the article turning unit is configured to receive the article at the in-feed position, hold the article while moving the article between the in-feed position and the output position, and release the article at the output position. The article holder 150 is further configured to change an orientation of the article from an input orientation at the in-feed position to an output orientation at the output position. In order to change the orientation of an article held by the article holder, the article holder is rotatable about a second axis A₂. The first axis A₁ and the second axis A₂ may be non-parallel to one another; for instance, in FIG. 1, the second axis is perpendicular to the first axis. In some examples, the second axis A₂ may not intersect with the first axis.

In some examples, the article holder 150 may be configured to receive and hold the article using a suction force (e.g. using a vacuum). The article holder may be configured to begin to apply the suction force at the in-feed position, or when the article holder is at a point in its orbital path between the output position and the in-feed position and moving towards the in-feed position, and to continue to apply the suction force until the article holder reaches the output position, at which point the article holder may be configured to stop applying the suction force in order to release the article.

Rotation of the article holder 150 about the second axis A₂ is driven by the article turning gear 160, which is coupled to the article holder to enable rotation of the article holder about the second axis A₂. In FIG. 1, a reducer 190 is provided between the article turning gear and the article holder (as described in more detail below); in other examples, the article turning gear may be directly connected to the article holder (e.g. the article turning gear and article holder may be mounted on a same shaft) such that the article holder is configured to rotate with the article turning gear.

The gear sections 120, the track sections 130, the article turning gear 160 and the track engagement element 170 are together configured such that, at any point in the orbital path of the article turning unit about the first axis A₁, either the article turning gear 160 is engaged with one of the gear sections 120 or the track engagement element 170 is engaged with one of the track sections 130. In this way, the orbital path of article turning gear alternates between segments along which the article holder rotates about the second axis A₂, due to engagement of the article turning gear with one of the gear sections, and segments along which the article holder does not rotate about the second axis A₂, during which the track engagement element is engaged with one of the track sections.

The arrangement of the gear sections 120 and track sections 130 around the circumference of the central shaft 110 thus enables the article holder 150 to have a first orientation aligned with the input orientation of the article while moving along a first segment of the orbital path that includes the in-feed position, to rotate from the first orientation to a second orientation aligned with the output orientation of the article while moving along a second segment of the orbital path, to have the second orientation while moving along a third segment of the orbital path that includes the output position, and to rotate from the second orientation to the first orientation while moving along a fourth segment of the orbital path. In other words, a 360°rotation of the body about the first axis A₁ comprises a first rotation of the body 180 about the first axis, during which the article holder does not rotate about the second axis, a second rotation of the body about the first axis, during which the article holder rotates about the second axis, a third rotation of the body about the first axis, during which the article holder does not rotate about the second axis and a fourth rotation of the body about the first axis, during which the article holder rotates about the second axis. The lack of rotation of the article holder about the second axis A₂ at the in-feed position and the output position enables the article to be transferred to and from the article holder (i.e. the body may be undergoing the first rotation when the article holder is at the in-feed position and undergoing the third rotation when the article holder is at the output position, or vice versa).

The amount by which the body 180 rotates during each of the first, second, third and fourth rotations (and therefore the length of each segment of the orbital path of the article holder) depends on the length of the gear section 120 or track section 130 (relative to the overall circumference of the central shaft 110) with which the article turning unit 140 is engaged while moving along the respective segment of the orbital path. In some examples, the segments of the orbital path of the article holder may have different lengths. For instance, if the device 100 is designed to change an orientation of a rectangular-shaped article by 90°, the track sections may be configured such that the body rotates by a greater amount during the first rotation than the third rotation (i.e. a first track section is longer than a second track section), as a longer segment during which the article holder does not rotate will be required at the transfer position (i.e. the in-feed position or output position) at which the side of the article parallel to (or closest to parallel to) the direction of movement of the article is longer. The device may then be configured such that the article holder is at the in-feed position while the body is undergoing the first rotation if the input orientation of the article is such that the longest side of the article is parallel to the direction of movement of the article, or such that the article holder is at the output position while the body is undergoing the first rotation if the output orientation of the article is such that the longest side of the article is parallel to the direction of movement of the article.

For example, the gear sections 120 and track sections 130 may be configured such that the body 180 rotates by 90° during the first rotation, 115° during the second rotation, 40° during the third rotation, and 115° during the fourth rotation. This would provide segments of the orbital path during which the article holder 150 does not rotate that are the same as or similar to conventional devices for changing the orientation of a rectangular-shaped article.

In another example, the gear sections 120 and track sections 130 may be configured such that the body 180 rotates by 90° during the first rotation, 120° during the second rotation, 30° during the third rotation, and 120° during the fourth rotation. This would provide a simpler gear ratio between the article turning gear 160 and each gear section (in examples in which the article turning gear is configured to rotate about its axis of rotation by 360°, 180° or 90° over the length of each gear section).

In FIG. 1, each gear section 120 is a bevel gear section, and the article turning gear 160 is a bevel gear, with the pitch angles of the article turning gear and each gear section configured such that the axis of rotation of the article turning gear is perpendicular to the first axis A₁. It will be understood that other pitch angles may be used if a different (non-zero) angle between the first axis A₁ and the axis of rotation of the article turning gear is desired. Depending on how the article holder 150 is coupled to the article turning gear, the axis of rotation of the article turning gear may be co-axial with the second axis A₂ (as is the case in the device 100 illustrated in FIG. 1), or parallel to but not co-axial with the second axis A₂.

The skilled person will appreciate that other types of gear may be used for the gear sections 120 and the article turning gear 160, depending, for example, on the design requirements of the device 100. For instance, hypoid gears may be used to provide a device in which the axis of rotation of the article turning gear does not intersect with the first axis A₁.

The gear ratio between the article turning gear 160 and each gear section 120 will depend on the angle subtended by the gear section from the first axis A₁ (i.e. the amount by which the body 180 rotates while the article turning gear is engaged with the gear section) and on a desired rotation of the article turning gear over the length of the gear section (i.e. between a first end of the gear section and a second, opposite end of the gear section). The desired rotation of the article turning gear may depend on a desired position of the track engagement element at each end of the gear section, as described in more detail below.

The track engagement element 170 may be coupled to the article turning gear 160 such that the engagement of the track engagement element with one of the track sections 130 restricts rotation of the article turning gear. For instance, the track engagement element may be offset from the axis of rotation of the article turning gear and coupled to the article turning gear such that rotation of the article turning gear about its axis of rotation causes the track engagement element to move about the axis of rotation of the article turning gear. Each track section defines a circumferential arc perpendicular to the first axis A₁, such that engagement of the track engagement element with the first portion causes the track engagement element to move in an arc perpendicular to the first axis. Thus, engagement of the track engagement element with one of the track sections restricts or prevents movement of the track engagement element about the axis of rotation of the article turning gear, thus ensuring that the article turning gear does not rotate about its axis (and therefore the article holder does not rotate about the second axis A₂) during engagement of the track engagement element with one of the track sections. In another example, the track engagement element may be an elongated element (e.g. an elongated slider) that is unable to rotate when engaged with one of the track sections.

The track engagement element 170 may be any element configured to engage with each track section 130 such that the track engagement element is movable along a path defined by the track section. In FIG. 1, each track section comprises a pair of rails, and the track engagement element comprises a roller configured to move within the pair of rails. In other examples, each track section may comprise a pair of rails, and the track engagement element may comprise a slider configured to slide within the pair of rails. In yet other examples, each track section may comprise a single rail, and the track engagement element may comprise a pair of sliders (or a pair of rollers), each slider (or roller) being configured to engage with a respective side of the rail to thereby move along the rail (i.e. such that the rail is between the sliders/rollers). Other suitable configurations of the track sections and track engagement element will be apparent to the skilled person.

It is to be understood that any mechanism that enables the article turning unit to move along segments of the orbital path without the article holder rotating (for instance, a catch or a brake mechanism incorporating a position restricting element such as a positioning clutch) may be used in place of the track sections and track engagement element.

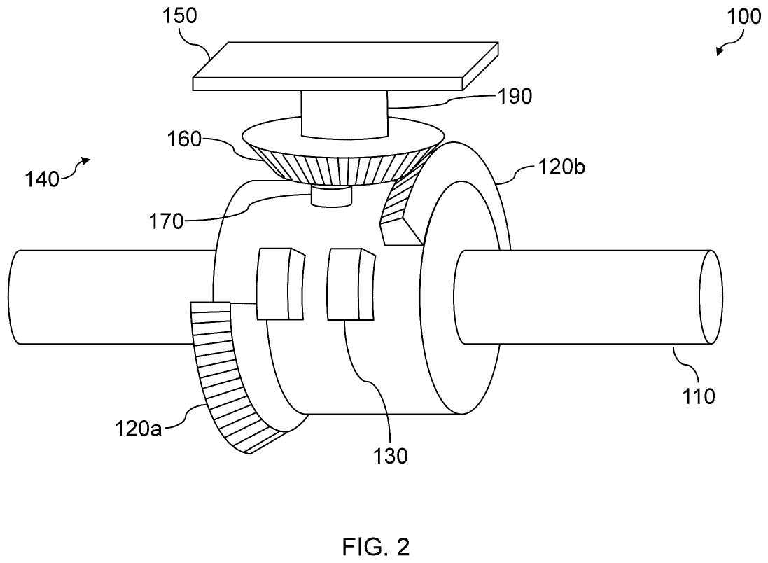

FIG. 2 illustrates a schematic perspective view of the device 100, which shows more clearly the arrangement of the gear sections 120 and track sections 130 around the circumference of the central shaft 110.

In FIG. 2, both gear sections are visible: a first gear section 120a and a second gear section 120b. The first gear section is provided on a first side of a plane that is perpendicular to the first axis A₁ and contains the axis of rotation of the article turning gear 160, while the second gear section is provided on a second, opposite side of this plane. In this way, engagement of the article turning gear with the first gear section causes the article turning gear to rotate in a first direction, and engagement of the article turning gear with the second gear section causes the article turning gear to rotate in a second, opposite direction. For instance, engagement of the article turning gear with the first gear section may cause the article turning gear to rotate in a clockwise direction, and engagement of the article turning gear with the second gear section may cause the article turning gear to rotate in a counterclockwise direction (or vice versa, depending on the input and output orientations of the article). In this way, the article holder may have the same input orientation each time the article holder reaches the in-feed position and the same output orientation each time the article holder reaches the output position.

In other examples, the gear sections may be configured such that engagement of the article turning gear with each gear section causes the article turning gear to rotate in the same direction (for instance, the gear sections may lie in the same plane). However, in a device configured to rotate the article holder by 90° between the in-feed position and output position, this would require the design of the article holder to be symmetric.

FIG. 2 also illustrates that the track section 130 overlaps the first gear section 120a in a circumferential direction, while there is a gap between the track section and the second gear section 120b. The overlap and gap are due to the offset between the axis of rotation of the article turning gear 160 and the track engagement element 170 (with the length of the overlap and the length of the gap each depending on the shortest distance, in a circumferential direction, between the axis of rotation and a part of the track engagement element that is configured to make contact with the track section), so that the article turning gear disengages from the first gear section at the point at which the track engagement element begins to engage with the track section, and the track engagement element disengages from the track section at the point at which the article turning unit begins to engage with the second gear section. Similarly, the other track section (which is not visible in FIG. 2) overlaps the second gear section 120b in a circumferential direction, while there is a gap between the other track section and the first gear section 120a.

Whether there is an overlap or a gap between a gear section and an adjacent track section will depend on the direction of rotation of the body and the position of the track engagement element with respect to the axis of rotation of the article turning gear. An overlap will be provided between a gear section and an adjacent track section if the track engagement element is behind the axis of rotation of the article turning gear when moving from the gear section to the track section (i.e. if the axis of rotation of the article turning gear reaches the track section before the track engagement element does), or if the track engagement element is in front of the axis of rotation of the article turning gear when moving from the track section to the gear section (i.e. if the track engagement element reaches the gear section before the axis of rotation of the article turning gear does). Similarly, a gap will be provided between a gear section and an adjacent track section if the track engagement element is behind the axis of rotation of the article turning gear when moving from the track section to the gear section, or if the track engagement element is in front of the axis of rotation of the article turning gear when moving from the gear section to the track section.

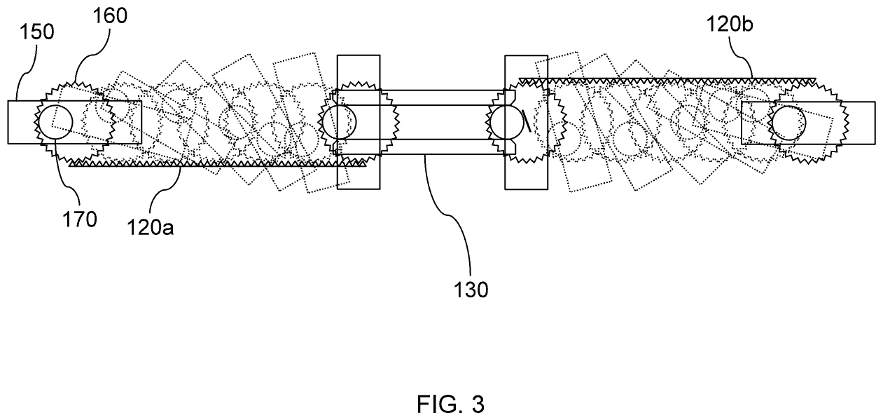

FIG. 3 illustrates a part of the orbital path of the article turning gear 160 and article holder 150 of the device 100 about the first axis A₁.

Between a first end of the first gear section 120a and a second, opposite end of the first gear section, the article turning gear 160 rotates in a clockwise direction by 360°. In this way, the track engagement element 170 has the same position with respect to the article turning gear at the second end of the first gear section as at the first end, so that the track engagement element is aligned with the track section 130.

As stated above, the article turning unit 140 of the device 100 comprises a reducer 190 (not visible in FIG. 3) provided between the article turning gear 160 and the article holder 150. The reducer is configured to modify an amount of rotation of the article holder relative to an amount of rotation of the article turning gear, such that the article holder is configured to rotate at a slower rate than the article turning gear. In the example of the device 100, the reducer has a reduction ratio of 1:4. In this way, while the article turning gear rotates by 360°, the article holder rotates by 90° in a clockwise direction between the first end of the first gear section and the second end. In this way, the article holder has an input orientation at the first end of the first gear section and an output orientation at the second end of the first gear section.

Once the track engagement element 170 begins to engage with the track section 130 and the article turning gear 160 disengages from the first gear section 120a, the article turning gear and article holder move, without rotating, along the circumferential path defined by the track section, until the track engagement element disengages from the track section and begins to engage with the second gear section 120b at a first end of the second gear section.

Between the first end of the second gear section 120a and a second, opposite end of the second gear section, the article turning gear 160 rotates by 360° in a counterclockwise direction, and the article holder rotates by 90° in a counterclockwise direction, returning the article holder to the input orientation. For illustrative purposes, the remaining track section is not included in FIG. 3; the skilled person will appreciate that the article turning gear and article holder move without rotating once the track engagement element is engaged with the remaining track section, such that the article holder is returned to the first end of the first gear section with the input orientation.

The inclusion of the reducer 190, and the reduction ratio of the reducer (if included in the article turning unit), depends on the input and output orientations, and on the amount by which the article turning gear 160 is configured to rotate over the length of each gear section (i.e. on the gear ratio between the article turning gear and each gear section). For instance, the article turning gear may be configured to rotate by 180° between the first end and second end of each gear section, so that the track engagement element reaches one track section before the axis of rotation of the article turning gear does, and reaches the other track section after the axis of rotation of the article turning gear does. To provide a 90° rotation of the article holder between the first end and second end of each gear section, a reducer having a reduction ratio of 1:2 may be provided between the article turning gear and the article holder. In some examples, the reducer may be omitted, and the article holder may rotate at the same rate as the article turning gear.

The device 100 has track sections 130 that each define a circumferential arc perpendicular to the first axis A₁ along the entire length of the respective track section. In some examples, only a first portion of each track section may define a circumferential arc perpendicular to the first axis, and a transition region may be provided at one or both ends of the track section to control acceleration and deceleration of the article turning gear (and thus reduce impact on the article turning gear) when moving between a gear section and a track section.

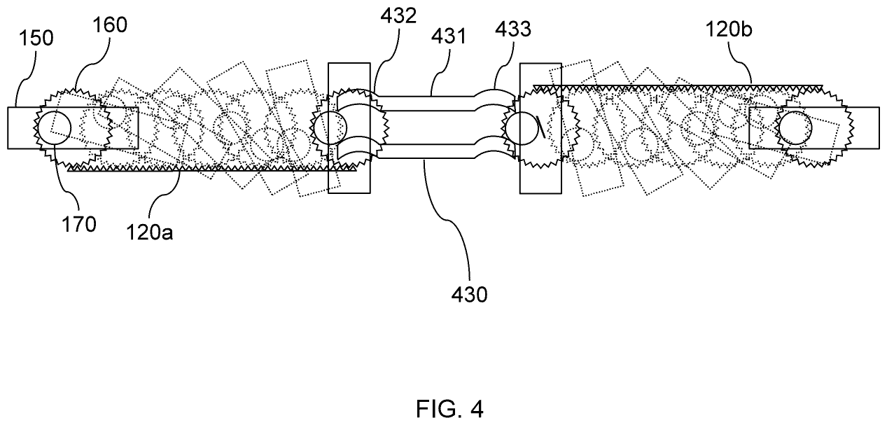

FIG. 4 illustrates a part of the orbital path of an article turning gear and article holder of another device for changing an orientation of an article. The article holder 150, article turning gear 160 and track engagement element 170 of the device having the orbital path shown in FIG. 4 are identical to the article holder 150, article turning gear 160 and track engagement element 170 of the device 100 described with reference to FIGS. 1 to 3; however, each track section 430 comprises a first portion 431, a first transition region 432 provided at a first end of the track section, and a second transition region 433 provided at a second, opposite end of the track section.

Each transition region 432, 433 is curved so as to deviate in an axial direction from a circumferential arc perpendicular to the first axis A₁. Due to this deviation, engagement of the track engagement element 170 with each transition region causes the track engagement element to move about the axis of rotation of the article turning gear 160, resulting in rotation of the article turning gear about its axis of rotation. In this way, the rotation of the article turning gear decelerates over the first transition region 432, before rotation of the article turning gear is restricted as the track engagement element engages with the first portion 431 of the track section 430. Rotation of the article turning gear is then accelerated over the second transition region 433 before the article turning gear engages with the second gear section 120b.

The transition regions illustrated in FIG. 4 are curved such that a path of movement of the track engagement element 170 has a smooth curvature between the first gear section 120a and the first transition region 432 and between the second transition region 433 and the second gear section 120b (i.e. the change in the direction of movement of the track engagement element is continuous when moving between each transition region and an adjacent gear section).

While engaged with the first portion 433 of the track section 430, the track engagement element 170 moves in a circumferential path perpendicular to the first axis A₁, the circumferential path forming an arc of a first circle. In FIG. 4, the first transition region 432 is curved such that, between the first gear section 120a and the first portion of the track section, the path of the track engagement element 170 moves away from the first circle before moving back to the first circle. In this way, the orientation of the article turning gear 160 and the article holder 150 are returned to the orientation each had at the second end of the first gear section, ensuring that the article holder has a desired orientation while the track engagement element is engaged with the first portion of the track section. Similarly, the second transition region 433 is curved such that, between the first portion of the track section and the second gear section 120b, the path of the track engagement element 170 moves away from the first circle before moving back to the first circle, such that the orientation of the article turning gear 160 and the article holder 150 are again returned to the orientation each had at the second end of the first gear section. Alternatively, each transition region may deviate from the first circle in one direction only, and the amount of rotation of the article holder over the length of each transition region may be taken into account when configuring the amount of rotation of the article holder over each gear section.

It is to be understood that, while the track section 430 illustrated in FIG. 4 has transition regions 432, 433 that are curved so as to deviate in an axial direction from a circumferential arc perpendicular to the first axis, each transition region may have any shape that causes the track engagement element to move in a direction that is non-perpendicular to the first axis A₁. For instance, each transition region may be slanted such that the track engagement element moves in a helical path along the transition region.

Although the track section 430 illustrated in FIG. 4 has transition regions at both ends, it is to be understood that, in some examples, a track section may have a transition region at only one end.

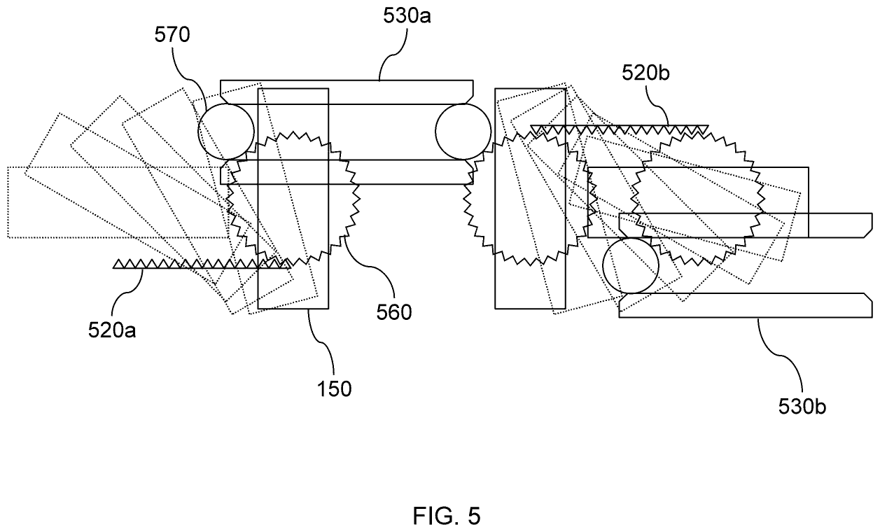

FIG. 5 illustrates a part of the orbital path of an article turning gear and article holder of yet another device for changing an orientation of an article. FIG. 5 provides a suitable example of an arrangement of gear sections 520a, 520b, and track sections 530a, 530b in a device in which a reducer is not included in the article turning unit (i.e. the article holder 150 is configured to rotate at the same rate as the article turning gear).

In FIG. 5, the article turning gear 560 and the article holder 150 rotate in a clockwise direction by 90° between the first end of the first gear section 520 a and the second, opposite end of the first gear section, at which point the track engagement element 570 engages with the first track section 530a at a first end of the first track section. At a second, opposite end of the first track section, the article turning gear engages with the second gear section 520b at the first end of the second gear section. Between the first end of the second gear section and the second, opposite end of the second gear section, the article turning gear and the article holder rotate by 90° in a counterclockwise direction, thus returning the article turning gear and the article holder to the orientation each had at the first end of the first gear section. At the second end of the second gear section, the track engagement element engages with the second track section 530b.

The 90° clockwise rotation of the article turning gear 560 along the first gear section 520 a results in the track engagement element 570 having a first position with respect to the article turning gear while engaging with the first track section 530 a, while the 90° counterclockwise rotation of the article turning gear along the second gear section 520b results in the track engagement element having a second, different position with respect to the article turning gear while engaging with the second track section 530b. As the track engagement element 570 has a different position with respect to the article turning gear while engaging with each track section, the first and second track sections are offset from one another.

The device 100 illustrated in FIGS. 1 and 2 has a single article turning unit. However, in some examples, a device for changing an orientation of an article may comprise a plurality of article turning units, each article turning unit comprising an article holder and an article turning gear as described above, with each article turning unit being mounted to the body of the device so that each article turning unit is rotatable about a first axis (or each article turning unit being mounted to a different body that is rotatable about the first axis).

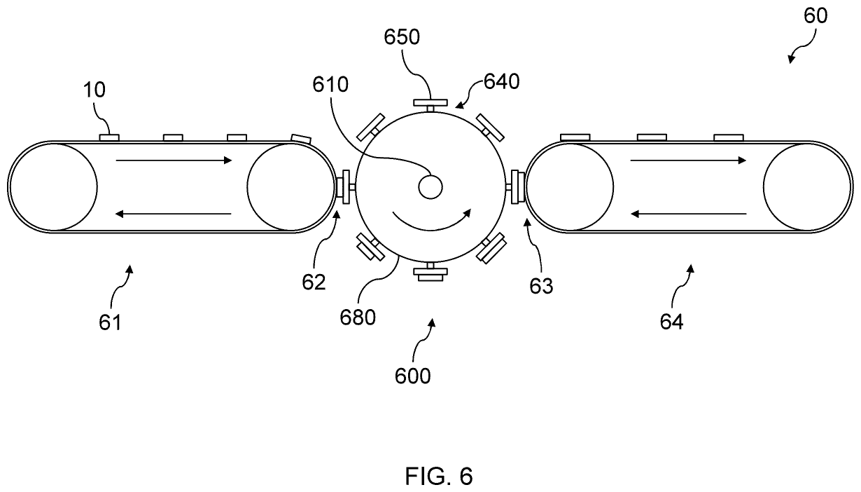

FIG. 6 illustrates an example apparatus 60 in which a device for changing an orientation of an article, according to the present disclosure, may be used. The apparatus 60 comprises an input conveyor 61, an output conveyor 64 and a device 600 for changing an orientation of an article, according to an example. The apparatus 60 may, for instance, form part of a system for manufacturing and/or packaging an article.

The input conveyor 61 is configured to convey at least one article 10 to an in-feed position 62 of the device 600. In FIG. 6, a plurality of articles are conveyed by the input conveyor as part of a flow of moving articles.

The device 600 is configured to change the orientation of the at least one article 10 while moving the article from the in-feed position 62 to an output position 63. The device 600 comprises a plurality of article turning units 640, each as described above, a body 680, and a central shaft 610. The body is configured to rotate about a first axis that is co-axial with the central shaft, and each article turning unit 640 is mounted to the body such that each article turning unit is rotatable about the first axis. In FIG. 6, the article turning units 640 are mounted to the same body 680, which takes the form of a housing; however, in some examples, the device may comprise more than one body (e.g. with each body taking the form of a rotatable arm), and different article turning units may be mounted to different bodies (e.g. each article turning unit may be mounted to a respective body).

As each article 10 reaches the in-feed position 62, the article is received by an article holder 650 of one of the article turning units 640. The article is then held by the article holder as the body rotates about the first axis, thus moving the article in an orbital path about the first axis from the in-feed position to the output position 63, where the article is released by the article holder. The output conveyor 64 is configured to receive the article from the article holder at the output position 63, and to convey the at least one article away from the output position.

As described above, each article turning unit 640 is configured to change an orientation of an article from an input orientation to an output orientation while moving the article from the in-feed position 62 to the output position 63. The device 600 may be configured such that the in-feed position and the output position each coincide with a respective track section, so that the article holder of each article turning unit does not rotate that the in-feed and output positions, and rotates while moving between the in-feed position and the output position.

In some examples, the apparatus 60 may be configured to adjust a pitch between adjacent articles in a flow of moving articles, by configuring the input conveyor and output conveyor to convey articles at different speeds from one another. Thus, adjacent articles may have a first pitch while being conveyed to the in-feed position 62 by the input conveyor 61, and a second, different pitch while being conveyed away from the output position 63 by the output conveyor 64.

In some examples, a first operation (e.g. a step in manufacturing or packaging the article that requires the article to have the input orientation) may be performed on each article 10 as the article is conveyed along the input conveyor 61 and/or a second operation (e.g. a step in manufacturing or packaging the article that requires the article to have the output orientation) may be performed on each article 10 as the article is conveyed along the output conveyor 64.

It is to be understood that the input conveyor 61 is one example of a mechanism by which the at least one article 10 is conveyed to the in-feed position 62, and that any suitable mechanism for conveying the at least one article 10 to the in-feed position 62 (e.g. a rotating drum) may be used in place of the input conveyor. Similarly, any suitable mechanism for conveying the at least one article 10 away from the output position 63 may be used in place of the output conveyor 64.

### Combinations

A1. A device (100, 600) for changing an orientation of an article (10) while moving the article in an orbital path about a first axis (A₁) from an in-feed position (62) to an output position (63), the device comprising: a central shaft (110, 610) co-axial with the first axis, the central shaft comprising circumferentially alternating first sectors and second sectors, wherein a gear section (120, 120a, 120b, 520a, 520b) is provided on each first sector; an article turning unit (140, 640) comprising: an article holder (150, 650) for receiving the article at the in-feed position, holding the article while moving the article between the in-feed position and the output position, and releasing the article at the output position, the article holder being rotatable about a second axis (A₂) to rotate the article between an input orientation, at the in-feed position, and an output orientation, at the output position; and an article turning gear (160, 560) configured to engage with the gear sections on the central shaft, wherein the article turning gear is coupled to the article holder for rotating the article holder about the second axis; and a body (180, 680) that is rotatable about the first axis, wherein the article turning unit is mounted to the body so that the article turning unit is rotatable about the first axis.
A2. The device (100, 600) of paragraph A1, wherein: each gear section (120, 120a, 120b, 520a, 520b) is a bevel gear section; and the article turning gear (160, 560) is a bevel gear.
A3 The device (100, 600) of paragraph A1 or A2, wherein the first axis (A₁) and second axis (A₂) are non-parallel to one another.
A4. The device (100, 600) of paragraph A3, wherein the second axis (A₂) is perpendicular to the first axis (A₁).
A5. The device (100, 600) of any of paragraphs A1 to A3, wherein: a track section (130, 430, 530a, 530b) is provided on each second sector; and the article turning unit (140, 640) further comprises a track engagement element (170, 570) configured to engage with the track sections on the central shaft (110, 610).
A6. The device (100, 600) of paragraph A5, wherein the track engagement element (170, 570) is offset from an axis of rotation of the article turning gear (160, 560).
A7. The device (100, 600) of paragraph A5 or A6, wherein each gear section (120, 120a, 120b, 520a, 520b) overlaps in a circumferential direction with an adjacent track section (130, 430, 530a, 530b).
A8. The device (100, 600) of any of paragraphs A5 to A7, wherein at least a first portion (431) of each track section (130, 430, 530a, 530b) defines a circumferential arc perpendicular to the first axis (A₁), such that engagement of the track engagement element (170, 570) with the first portion causes the track engagement element to move in an arc perpendicular to the first axis.
A9. The device (100, 600) of paragraph A8, wherein each track section (430) further comprises a transition region (432, 433) at one or both ends of the track section, each transition region being curved so as to deviate in an axial direction from a circumferential arc perpendicular to the first axis (A₁).
A10. The device (100, 600) of any of paragraphs A5 to A9, wherein each track section (130, 430, 530a, 530b) comprises a pair of rails.
A11. The device (100, 600) of paragraph A10, wherein the track engagement element comprises a slider configured to slide within the pair of rails.
A12. The device (100, 600) of paragraph A10, wherein the track engagement element (170, 570) comprises a roller configured to move within the pair of rails.
A13. The device (100, 600) of any of paragraphs A5 to A9, wherein each track section comprises a rail.
A14. The device (100, 600) of paragraph A13, wherein the track engagement element comprises a pair of sliders, each slider being configured to engage with a respective side of the rail to thereby slide along the rail.
A15. The device (100, 600) of paragraph A13, wherein the track engagement element comprises a pair of rollers, each roller being configured to engage with a respective side of the rail to thereby move along the rail.
A16. The device (100, 600) of any of paragraphs A1 to A15, wherein the article turning unit (140, 640) further comprises a reducer (190) provided between the article turning gear (160, 560) and the article holder (150, 650), wherein the reducer is configured to modify an amount of rotation of the article holder relative to an amount of rotation of the article turning gear such that the article holder is configured to rotate at a slower rate than the article turning gear.
A17. The device (100, 600) of paragraph A16, wherein the reducer (190) has a reduction ratio of 1:4.
A18. The device (100, 600) of any of paragraphs A1 to A17, wherein the gear sections are configured such that engagement of the article turning gear (160, 560) with each gear section causes the article turning gear to rotate in the same direction.
A19. The device (100, 600) of any of paragraphs A1 to A17, wherein the gear sections (120, 120a, 120b, 520a, 520b) comprise: a first gear section (120a, 520a), configured such that engagement of the article turning gear (160, 560) with the first gear section causes the article turning gear to rotate in a clockwise direction; and a second gear section (120b, 520b), configured such that engagement of the article turning gear with the second gear section causes the article turning gear to rotate in a counterclockwise direction.
A20. The device (100, 600) of any of paragraphs A1 to A19, wherein the gear sections (120, 120a, 120b, 520a, 520b) and the article turning unit (140, 640) are together configured such that engagement of the article turning gear (160, 560) with each gear section causes the article holder (150, 650) to rotate by 90° between a first end of the gear section and a second, opposite end of the gear section.
A21. The device (100, 600) of any of paragraphs A1 to A20, wherein the first sectors and second sectors are configured such that a 360°rotation of the body about the first axis comprises: a first rotation of the body (180, 680) about the first axis, during which the article holder (150, 650) does not rotate about the second axis; a second rotation of the body about the first axis, during which the article holder rotates about the second axis; a third rotation of the body about the first axis, during which the article holder does not rotate about the second axis; and a fourth rotation of the body about the first axis, during which the article holder rotates about the second axis, wherein the body rotates by a greater amount during the first rotation than the third rotation.
A22. The device (100, 600) of paragraph A21, wherein the first sectors and second sectors are configured such that the body (180, 680) rotates by: 90° during the first rotation; 115° during the second rotation; 40° during the third rotation; and 115° during the fourth rotation.
A23. The device (100, 600) of paragraph A21, wherein the first sectors and second sectors are configured such that the body (180, 680) rotates by: 90° during the first rotation; 120°during the second rotation; 30° during the third rotation; and 120° during the fourth rotation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A device for changing an orientation of an article while moving the article in an orbital path about a first axis from an in-feed position to an output position, the device comprising:
a central shaft co-axial with the first axis, the central shaft comprising circumferentially alternating first sectors and second sectors, wherein a gear section is provided on each first sector;
an article turning unit comprising:
an article holder for receiving the article at the in-feed position, holding the article while moving the article between the in-feed position and the output position, and releasing the article at the output position, the article holder being rotatable about a second axis to rotate the article between an input orientation, at the in-feed position, and an output orientation, at the output position; and
an article turning gear configured to engage with the gear sections on the central shaft, wherein the article turning gear is coupled to the article holder for rotating the article holder about the second axis; and
a body that is rotatable about the first axis, wherein the article turning unit is mounted to the body so that the article turning unit is rotatable about the first axis.

2. The device of claim 1, wherein:
each gear section is a bevel gear section; and
the article turning gear is a bevel gear.

3. The device of claim 1, wherein the first axis and second axis are non-parallel to one another.

4. The device of claim 3, wherein the second axis is perpendicular to the first axis.

5. The device of claim 1, wherein:
a track section is provided on each second sector; and
the article turning unit further comprises a track engagement element configured to engage with the track sections on the central shaft.

6. The device of claim 5, wherein the track engagement element is offset from an axis of rotation of the article turning gear.

7. The device of claim 5, wherein each gear section overlaps in a circumferential direction with an adjacent track section.

8. The device of claim 5, wherein at least a first portion of each track section defines a circumferential arc perpendicular to the first axis, such that engagement of the track engagement element with the first portion causes the track engagement element to move in an arc perpendicular to the first axis.

9. The device of claim 8, wherein each track section further comprises a transition region at one or both ends of the track section, each transition region being curved so as to deviate in an axial direction from a circumferential arc perpendicular to the first axis.

10. The device of claim 5, wherein each track section comprises a pair of rails.

11. The device of claim 10, wherein the track engagement element comprises a slider configured to slide within the pair of rails.

12. The device of claim 10, wherein the track engagement element comprises a roller configured to move within the pair of rails.

13. The device of claim 5, wherein each track section comprises a rail.

14. The device of claim 13, wherein the track engagement element comprises a pair of sliders, each slider being configured to engage with a respective side of the rail to thereby slide along the rail.

15. The device of claim 13, wherein the track engagement element comprises a pair of rollers, each roller being configured to engage with a respective side of the rail to thereby move along the rail.

16. The device of claim 1, wherein the article turning unit further comprises a reducer provided between the article turning gear and the article holder, wherein the reducer is configured to modify an amount of rotation of the article holder relative to an amount of rotation of the article turning gear such that the article holder is configured to rotate at a slower rate than the article turning gear.

17. The device of claim 16, wherein the reducer has a reduction ratio of 1:4.

18. The device of claim 1, wherein the gear sections are configured such that engagement of the article turning gear with each gear section causes the article turning gear to rotate in the same direction.

19. The device of claim 1, wherein the gear sections comprise:
a first gear section, configured such that engagement of the article turning gear with the first gear section causes the article turning gear to rotate in a clockwise direction; and
a second gear section, configured such that engagement of the article turning gear with the second gear section causes the article turning gear to rotate in a counterclockwise direction.

20. The device of claim 1, wherein the gear sections and the article turning unit are together configured such that engagement of the article turning gear with each gear section causes the article holder to rotate by 90° between a first end of the gear section and a second, opposite end of the gear section.
